(19) United States
(12) Patent Application Publication
(10) Pub. No.: US 2025/0089943 A1
(43) Pub. Date: Mar. 20, 2025

(54) CLAMSHELL TOASTER

(71) Applicant: STEARNS PRODUCT DEVELOPMENT CORPORATION, Perris, CA (US)

(72) Inventor: Howard Frantz, Irvine, CA (US)

(21) Appl. No.: 18/882,637

(22) Filed: Sep. 11, 2024

Related U.S. Application Data
(60) Provisional application No. 63/538,721, filed on Sep. 15, 2023.

(51) Int. Cl. A47J 37/08

(52) U.S. Cl. CPC A47J 37/0864; A47J 37/0871

(57) ABSTRACT

A clamshell toaster comprising a toasting platen having a planar toasting surface configured for toasting a plurality of buns. An upper body is moveable relative to the planar toasting surface between a raised position and a lowered position, with the upper body moving toward the planar toasting surface as the upper body transitions from the raised position towards the lowered position. The clamshell toaster additionally includes a resilient compression element comprising a base and a plurality of compression fingers extending from the base, the base being configured to be slidably engageable with the upper body, the plurality of compression fingers extending from the base at a non-perpendicular angle.

### CROSS-REFERENCE TO RELATED APPLICATIONS

This application claims the benefit of U.S. Provisional Application Ser. No. 63/538,721, filed Sep. 15, 2023, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to toasters, and more specifically to a clamshell toaster having a plurality of independently compressible compression fingers capable of compressing buns that vary in thickness against a common heat platen.

### 2. Description of the Related Art

Many individuals prefer a toasted bun on their hamburger or cheeseburger, rather than an untoasted bun. It is believed that toasting the bun creates a thin, caramelized layer that may serve as a barrier or impediment to moisture or sauces from penetrating into the bun to prevent sogginess.

Many believe that toasting buns on a flat top griddle provides a better toast quality than other toasting techniques. However, it can take as much as five minutes to get a deep, quality toast on a flat top griddle. This timing oftentimes does not align with the throughput requirements of many food service operations.

It is well known that the toasting process can be accelerated by adding a small amount of weight to the top of the bun. This compresses the bun to enhances direct contact with the griddle, which in turn increases the rate of conductive heat transfer to the bun.

Over the years, cooks have improvised many informal methodologies of adding weight to the bun. Common examples include adding a folded towel, another bun, or a weighted disk to the top of the bun while the bun sits on the grill. While some have been effective at improving toast quality, many techniques would not meet health department standards or be considered labor efficient.

The deficiencies associated with the informal techniques were remedied by recent clamshell attachments to horizontal griddles. These assemblies allow a hinged clamshell device to be lowered to compress the buns, and then the hinged portion was raised at the completion of the toasting cycle. The conventional hinged clamshells provide compression either by weighted members extending down from the clamshell mechanism to engage the bun or using a resilient material to transfer force to the bun top. They are designed to meet all health department and NSF (National Sanitation Foundation) standards while providing excellent toast quality.

While the conventional clamshell toasters provided an improvement over the historical techniques, to date, clamshell toasters suffer from several deficiencies. One drawback with conventional contact toasters is that the buns must be lined up on the grill surface in a regimented fashion, i.e., crowns (tops) on the left side and heels (bottoms) on the right side. While this works for some restaurant operations, it is impractical for others. Another deficiency is that conventional clamshell toasters are typically calibrated for a single size bun (for example 4″ diameter). Again, this may be practical for some restaurants but not work for others, as many restaurants have a mix of bun sizes for different products. Another limitation associated with conventional clamshell toasters is that they are typically designed to work best with a left or right side hinge only whereas some applications may require a rear hinged clamshell.

Accordingly, there is a need in the art for a toaster that can provide optimal toasting of a variety of buns, while also allowing for ease of use in a restaurant environment. Various aspects of the present disclosure address this particular need, as will be discussed in more detail below.

### BRIEF SUMMARY

In accordance with one embodiment of the present disclosure, there is provided a clamshell toaster comprising a toasting platen having a planar toasting surface configured for toasting a plurality of buns. An upper body is moveable relative to the planar toasting surface between a raised position and a lowered position, with the upper body moving toward the planar toasting surface as the upper body transitions from the raised position towards the lowered position. The clamshell toaster additionally includes a resilient compression element comprising a base and a plurality of compression fingers extending from the base, with the base being configured to be slidably engageable with the upper body, the plurality of compression fingers extending from the base at a non-perpendicular angle.

The upper body may include a first end portion, a second end portion opposite the first end portion, and a channel extending between the first and second end portions. The base of the resilient compression element may be slidable within the channel. The upper body may include a main surface and a pair of side flanges each being spaced from the main surface and positioned at respective ones of the first and second end portions. The main surface and the pair of side flanges may define at least a portion of the channel. The upper body may additionally include a rear flange spaced from the main surface and the pair of side flanges, with the rear flange defining at least a portion of the channel. The pair of side flanges may each extend longitudinally in a first direction and the rear flange may extend longitudinally in a second direction perpendicular to the first direction.

The plurality of compression fingers may each be independently compressible relative to the other ones of the plurality of compression fingers. The plurality of compression fingers may be integrally formed with the base. The plurality of compression fingers may be arranged in a plurality of arrays. The compression fingers within a given array may be offset from the compression fingers in an adjacent array. Each compressible finger may include a rounded tip.

The upper body may be pivotable relative to the planar toasting surface between the raised position and the lowered position. The upper body may be pivotable and translatable relative to the planar toasting surface between the raised position and the lowered position.

The clamshell toaster may further include a stiffener coupled to the base.

According to another embodiment, there is provided a device for compressing a plurality of buns against a planar toasting surface of a toasting platen. The device includes an upper body configured to be moveable relative to the planar toasting surface between a raised position and a lowered position, with the upper body moving toward the planar toasting surface as the upper body transitions from the raised position towards the lowered position. The device further includes a resilient compression element comprising a base and a plurality of compression fingers extending from the base. The base is configured to be slidably engageable with the upper body, with the plurality of compression fingers extending from the base at a non-perpendicular angle.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a front upper perspective view of a clamshell toaster having angled compression elements in accordance with an embodiment of the present disclosure;

FIG. 2 is a rear upper perspective view of the clamshell toaster of FIG. 1;

FIG. 3 is a front view of the toaster of FIG. 1;

FIG. 4 is a side view of the clamshell toaster of FIG. 1 taken from a first side;

FIG. 5 is a side view of the clamshell toaster of FIG. 1 taken from an opposing second side;

FIG. 6 is a side, partial cross sectional view of the clamshell toaster in an open, raised position, with a plurality of buns on a toasting platen;

FIG. 7 is a side, partial cross sectional view of the clamshell toaster in an intermediate position, with an upper body of the clamshell toaster having been pivoted toward the buns from the open, raised position;

FIG. 8 is a side, partial cross sectional view of the clamshell toaster in a closed, lowered position, with the upper body of the clamshell toaster having been translated downwardly from the intermediate position to compress a plurality of compression fingers against the buns;

FIG. 9 is an enlarged side view of a portion of a compression element including the plurality of compression fingers extending from a base;

FIG. 10 is an enlarged side view of a plurality of compression elements interfacing with a bun; and

FIG. 11 is an upper perspective view of a second embodiment of a clamshell toaster installed for use over a griddle to compress food items against the griddle.

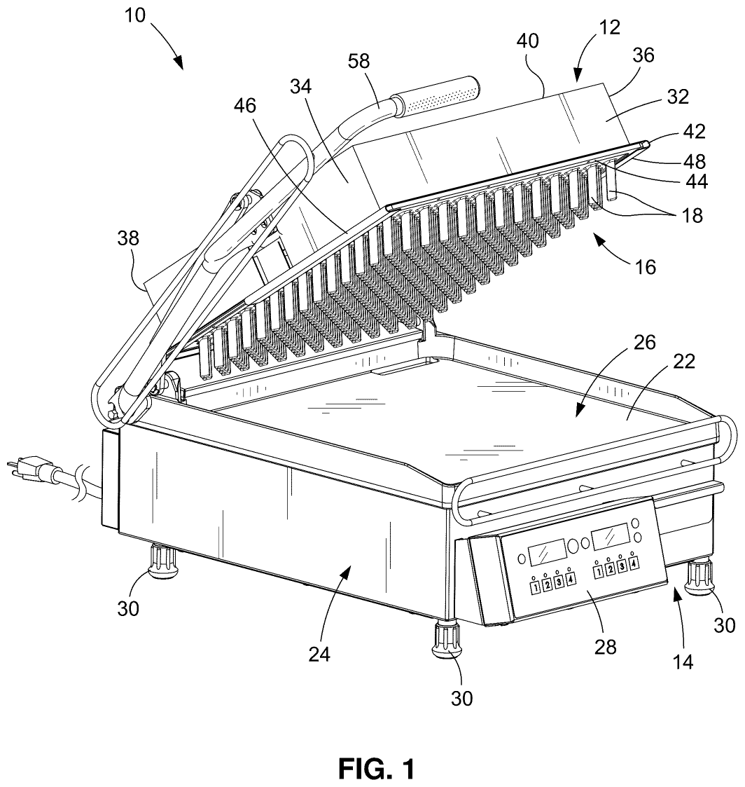

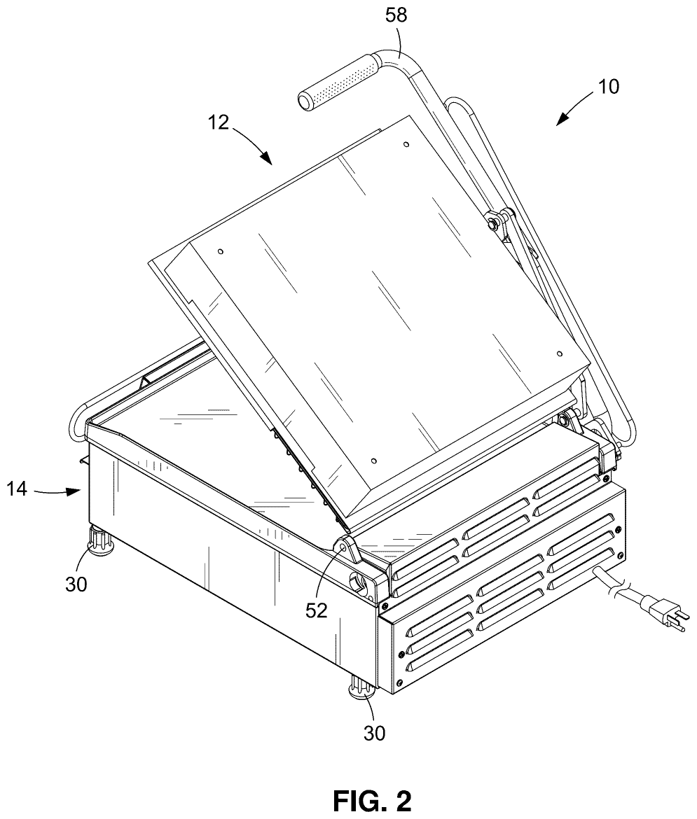

Common reference numerals are used throughout the drawings and the detailed description to indicate the same elements.

### DETAILED DESCRIPTION

The detailed description set forth below in connection with the appended drawings is intended as a description of certain embodiments of a clamshell toaster and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to a clamshell toaster for hamburger buns, with the toaster being specifically configured and adapted to apply sufficient pressure against the bun to urge the bun against a toasting surface while minimizing or eliminating damage to the bun. The pressure may be applied on the buns by a plurality of compression elements (e.g., fingers) that are angled relative to the toasting surface, with the angle of the compression elements being designed to minimize puncturing of the bun or causing permanent damage to the buns. The compression elements may accommodate different sizes and heights of buns, which may be critical in restaurants where a variety of buns are used for different sandwiches. The toaster may also impose no restrictions on where the buns can be placed under the clamshell, which may be advantageous in the fast-paced environment of a fast food restaurant.

Referring now to the drawings, wherein the showings are for purposes of illustrating a preferred embodiment of the present disclosure, and are not for purposes of limiting the same, there is depicted a clamshell toaster 10 generally comprising an upper body 12, a lower body 14 and a compression element 16 having a plurality of compression fingers 18 for compressing buns 20 against a toasting surface 22. The upper body 12 is moveable relative to the lower body 14 between a raised, open position and a lowered, closed position, as will be described in more detail below.

The lower body 14 may be comprised of a lower housing 24 and a toasting platen 26 coupled to the lower housing 24. The toasting platen 26 may include the planar toasting surface 22 which may be heated to toast the surface of each bun 20 that is in direct, abutting contact therewith. The toasting surface 22 may include a polytetrafluoroethylene (PTFE) exterior. It is also contemplated that the toasting surface 22 may be covered by a PTFE sheet that can be removed for cleaning or replacement. The toasting platen 26 may be connected to an electrical power source, such as an electrical outlet or a battery to provide the power that may be required to heat the toasting surface 22. The lower housing 24 may house electrical components needed to facilitate operation of the toasting platen 26. Furthermore, a control panel 28 may be mounted to the lower housing 24 and may be configured to facilitate operation of the toasting platen 26, e.g., turning on/off as well as controlling temperature and time of heat. A plurality of adjustable feet 30 may be coupled to the lower housing 24 and may be adjustable to facilitate leveling of the toasting surface 22 with a horizontal plane.

The upper body 12 may include a front wall 32, a pair of side walls 34, 36, a rear wall 38 opposite the front wall 32, and an upper wall 40. The front wall 32 may be at a first end portion (e.g., a front portion), while the rear wall 38 may be at an opposing second end portion (e.g., a rear portion). A channel 42 may extend between the first and second end portions. That is, the channel 42 may extend in a front-to-back direction. However, it is understood that in other embodiments, the channel 42 may extend in a side-to-side direction without departing from the spirit and scope of the present disclosure.

The upper body 12 may additionally include a main surface 44 and a pair of side flanges 46, 48 having a proximal segment extending away from the main surface 44 and a distal segment being spaced from the main surface 44. The distal segment may be parallel to the main surface 44 and may extend underneath the main surface 44. Each side flanges 46, 48 may be positioned at a respective first and second end portions. The main surface 44 and the pair of side flanges 46, 48 may define at least a portion of the channel 42. The upper body 12 may additionally include a rear flange 50 at the rear end portion. The rear flange 50 may be similar to the side flanges 46, 48 in that the rear flange 50 may include a proximal segment extending away from the main surface 44 and a distal segment spaced from the main surface 44 and extending underneath the main surface 44. The rear flange 50 may also define at least a portion of the channel 42. The pair of side flanges 46, 48 may each extend longitudinally in a first direction and the rear flange 50 may extend longitudinally in a second direction perpendicular to the first direction. As will be explained in more detail below, the flanges 46, 48, 50 may assist in retaining the compression element 16 to the upper body 12.

The upper body 12 may be pivotable and translatable relative to the planar toasting surface 22 between the raised, open position and the lowered, closed position. When in the raised, open position, the toasting surface 22 may be exposed to facilitate loading of the buns 20 on the toasting surface 22, as well as removal of the buns 20 from the toasting surface 22 once the buns 20 have been toasted. A spring may be operatively connected to the upper and lower bodies 12, 14 to provide a biasing force toward the raised position and to counter some of the weight of the upper body 12. The biasing of the spring may also help maintain the upper body 12 in the raised position during periods of non-use. In certain embodiments, the upper body 12 may be coupled to the lower body 14 via a compound hinge 52, which allows the upper body 12 to initially pivot from the raised, open position about a pivot axis until the upper body 12 assumes an intermediate position relative to the lower body 14. In the intermediate position, the main surface of the upper body 12 may be parallel to the toasting surface 22, while the compression fingers 18 may still remain spaced above the buns 20. The upper body 12 may then translate downwardly from the intermediate position toward the lowered, closed position to bring the compression fingers 18 into contact with the buns 20. In certain implementations, the upper body 12 may translate downwardly by approximately three inches as the upper body 12 moves from the intermediate position toward the lowered, closed position. One or more handles 58 may be coupled to the upper body 12 to facilitate movement of the upper body 12 relative to the lower body 14.

When the upper body 12 is in the closed, lowered position, the resiliency of the compression fingers 18, in addition to an optional spring mechanism, may bias the upper body 12 upwardly, or away from the toasting surface 22 and reduce the pressure being applied to the buns 20. To prevent the upper body 12 from moving upwardly and to maintain the pressure on the buns 20, the operator may hold down the upper body 12 during the toasting cycle. However, this may not be a labor efficient solution, and thus, one embodiment of the toaster 10 may be configured to retain the upper body 12 in place in the desired lowered, closed position. For instance, the toaster 10 may include a lock that is selectively actuatable when the upper body 12 is in the lowed position. The lock may include a pivoting arm that is extendable between the upper body 12 and the lower body 14 when the lower body 12 is in the lowered position. The arm may include a hook which is engageable with a loop or a locking post or other structure on the opposing one of the upper and lower bodies 12, 14. The lock may also include other mechanisms known in the art that are capable of retaining the upper body 12 in the lowered position, such as a passive detent pin, or an electromagnet that engages when the upper body 12 is lowered.

The toaster 10 may be configured to facilitate adjustment of the distance between the compression fingers 18 and the toasting surface 22 (e.g., referred to herein as the gap) when the upper body 12 is in the lowered, closed position. In this regard, different food products may physically require a larger gap or a smaller gap. For instance, tortillas would require a very small gap, while a croissant may require a much larger gap. Thus, the upper body 12 may be connected to the lower body 14 in a manner which facilitates such selective adjustment between the upper body 12 and the lower body 14/toasting surface 22. In one embodiment, the hinge 52 connecting the upper body 12 to the lower body 14 may be configured to allow for selective adjustment of the gap between the main surface 44 of the upper body 12 and the toasting surface 22 when the upper body 12 is in the lowered, closed position. However, other modalities may be used to control the size of the gap, such as using a selectively adjustable stop/rod to control the distance. The length of the stop may be increased to increase the size of the gap, or decreased to decrease the size of the gap. The stop may extend between the upper body 12 and the lower body 14, or between the upper body 12 and the toasting platen 26, or alternatively, to any associated structure which allows for control over the size of the gap.

The toaster 10 may be configured such that the upper body 12 may be hinged to the lower body 14 on either side of the toaster 10. In more detail, the upper body 12 may be hinged to the left side, right side, or rear of the toaster 10, as may be desired based on kitchen space, etc. The compression element 16 may be configured such that the compression fingers 18 are angled toward the hinge 52 to provide optimal engagement with the bun 20 as the upper body 12 is moved to the lowered, closed position.

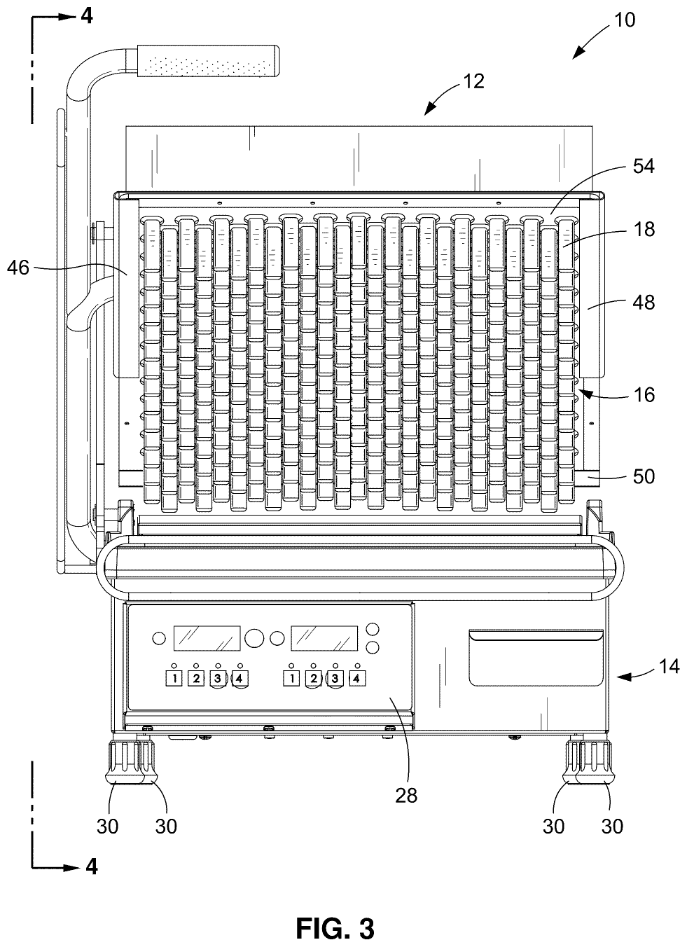

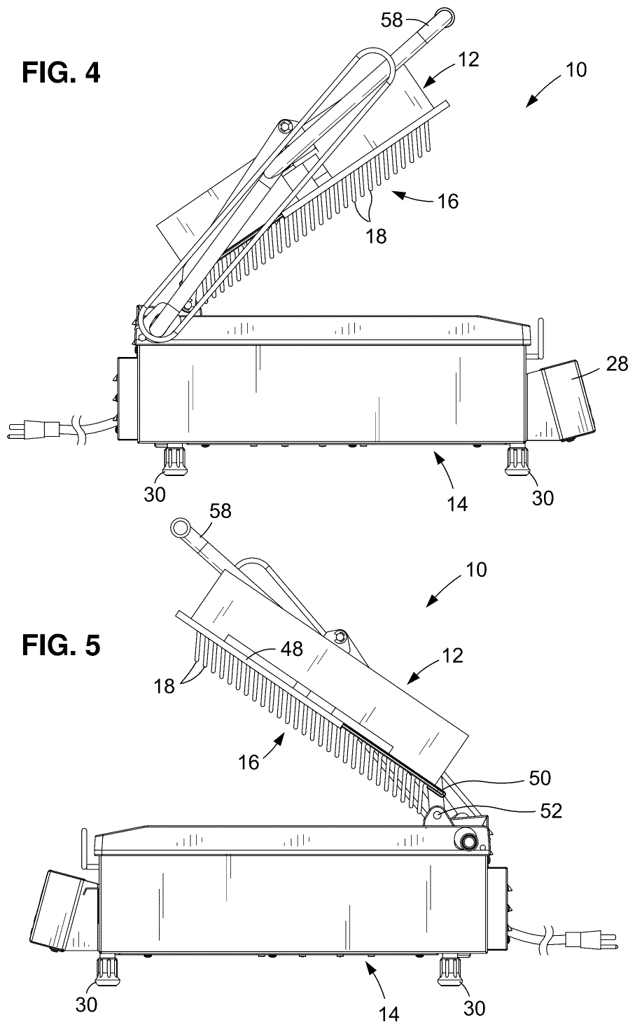

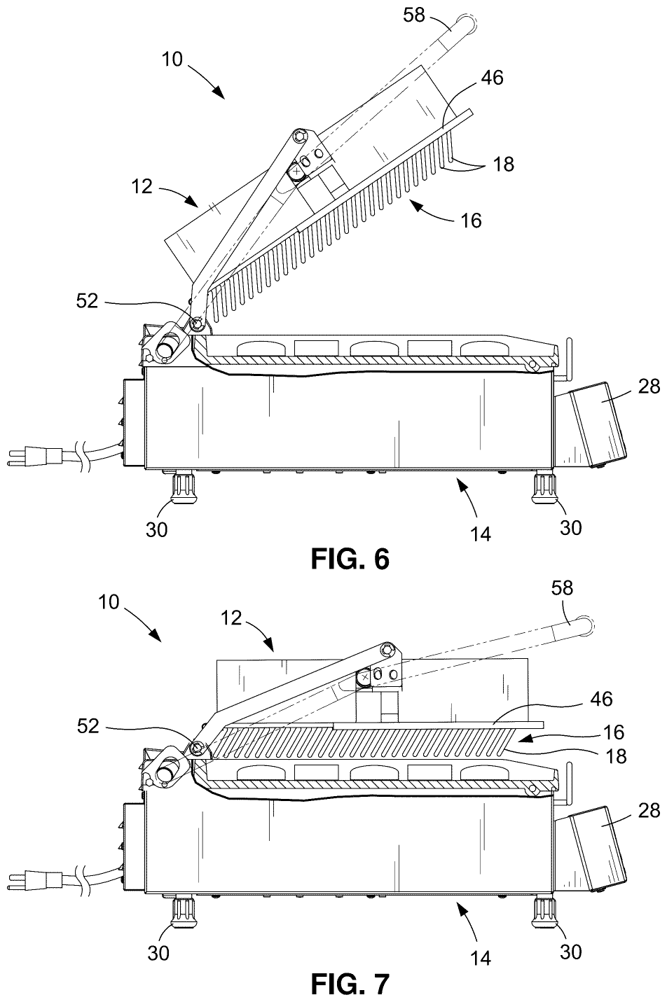

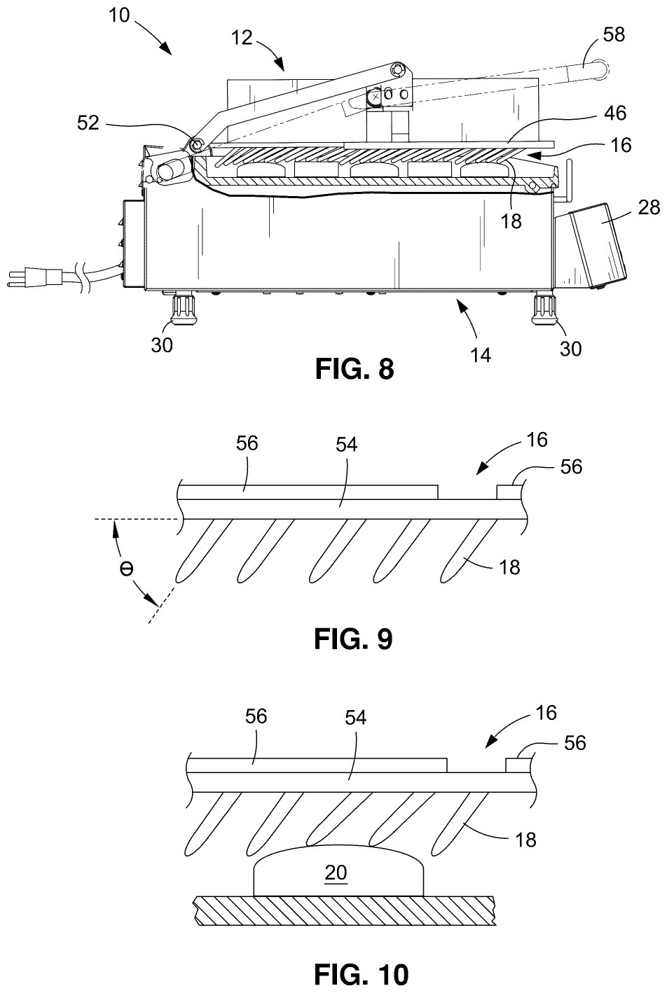

As noted above, the upper body 12 is configured to hold the resilient compression element 16, which includes a base 54 (see FIG. 3) and the plurality of compression fingers 18 extending from the base 54. The compression fingers 18 are configured to engage with the buns 20 and apply a small force on the buns 20 against the toasting surface 22 to enhance the toasting of the buns 20. The compression fingers 18 and the base 54 may be integrally formed with each other, such as being formed from a common mold. The compression fingers 18 are independently compressible to automatically adjust to the thickness of the bun 20 to apply sufficient pressure on the bun 20 for achieving desired toasting of the bun 20 by the toasting surface 22. The configuration and resiliency of the compression fingers 18 may accommodate buns 20 that vary in thickness rather than relying on a one size fits all approach. Therefore, the toaster 10 may be capable of providing more consistent bun toast across all bun thicknesses. Though the bun 20 is described above as being a hamburger bun, those of ordinary skill in the art will recognize that the toaster 10 as outfitted with those unique structural features described in more detail below may be adapted for use in conjunction with different food products or items for which toasting on one surface may be desirable, such as hot dog buns, bagels, tortillas, other non-bread products, etc.

In one particular embodiment, the compression fingers 18 extend at a non-perpendicular angle relative to an exposed surface of the base 54 when not interfacing with a bun (e.g., in a neutral state). This particular configuration may mitigate puncturing or deforming the buns 20 as the compression fingers 18 engage with the buns 20 and assume a flexed state. The problem of puncturing may be particularly relevant in the case of the crown half (e.g., the top half) buns 20. The angle Θ at which the compression fingers 18 may extend from the base 54 may be between 45-75 degrees, and in a particular embodiment, may be 60 degrees. However, the compression fingers 18 may extend at other angles without departing from the spirit and scope of the present disclosure. Moreover, to further reduce the chances of puncturing or marking the buns 20, the tip of each compression finger 18 may be rounded to reduce sharp edges on the compression finger 18.

The plurality of compression fingers 18 protrude or extend from the base 54 and may be sized and configured such that at least one, and preferably multiple compression fingers 18, will interface with any given bun 20 to evenly distribute the pressure applied to the bun 20. The plurality of compression fingers 18 may be arranged in a plurality of arrays. The compression fingers 18 within a given array may be offset from the compression fingers 18 in an adjacent array. Each compression finger 18 may include a rounded tip. The compression fingers 18 may be molded, formed or otherwise provided in any one of a multiplicity of different shapes and sizes. Along these lines, the compression fingers 18 included on the base 54 may all be of the same size and shape, or possibly provided in prescribed combinations of differing size and/or shape. Further, the compression fingers 18 may be molded directly onto the base 54 to minimize loose pieces or extra hardware, though they may alternatively comprise separate structures joined to the base 54 through the use of a prescribed attachment modality (e.g., an adhesive). Each compression finger 18 may be compressible (and capable of resiliently returning to its uncompressed state) independent of the adjacent compression fingers 18 to allow the compression fingers 18 to conform to the bun 20, i.e., each compression finger 18 may be resilient to apply a force on the bun 20 when the compression finger 18 engages with the bun 20 and is compressed by the bun 20. The independent, resilient compressibility may result in evenly distributed pressure on the bun 20 to achieve uniform toasting of the bun 20.

The compression fingers 18 may be formed from a high temperature, FDA grade silicone, which may be very durable, yet lightweight. Silicone may be capable of withstanding heat, may be food-safe and easily cleanable, and is widely used in the food service industry. Silicone may also have sufficient internal resilience to generate a spring-like force when compressed. Although silicone is explicitly mentioned as a possible material for the compression fingers 18, it is contemplated that other suitable food-safe materials known by those skilled in the art may also be used to form the compression fingers 18 without departing from the spirit and scope of the present disclosure. The compression fingers 18 may be hollow to allow for easier compression when engaging with the bun, although it is understood that the compression fingers 18 may also be solid without departing from the spirit and scope of the present disclosure.

The compression element 16 may be formed of materials that vary in durometer, depending on the intended use. For instance, very firm products, such as bagels may need a stiffer compression finger 18, while softer products, such as hamburger buns, may need a softer material. Thus, different compression elements 16 may be swapped out of the upper body 12 depending on the food item that is to be toasted. Furthermore, the compression elements 16 may be color coded to help identify one durometer from another.

Although the exemplary compression fingers 18 are depicted in the shape of elongate projections, e.g., fingers or fins, it is understood that the scope of the present disclosure is not limited thereto. For instance, the compression fingers 18 may be in the form of bristles, nubs, or other projecting structures known by those skilled in the art. For more information regarding the configuration, arrangement, and use of compression fingers/gripping bodies, please refer to U.S. Pat. No. 11,717,111 entitled CONTACT TOASTER INCLUDING INDEPENDENT COMPRESSIBLE GRIPPING MEMBERS and U.S. application Ser. No. 18/817,805, filed Aug. 28, 2024, entitled CONTACT TOASTER WITH BELT, the contents of each of which are incorporated herein by reference.

According to one embodiment, the compression element 16 may be configured such that the compression element 16 may be configured for quick and easy removal from the upper body 12, which may be required for routine cleaning and maintenance of the compression element 16. To facilitate such removal, the base 54 of the compression element 16 may be configured for slidable engagement with the upper body 12, with the base 54 being configured to be received within the channel 42 of the upper body 12. In more detail, the base 54 may include peripheral regions that may be captured by the side flanges 46, 48 as well as the rear flange 50 to hold or retain the base 54 adjacent the main surface of the upper body 12. When loading the compression element 16 onto the upper body 12, the base 54 may be aligned with the side flanges 46, 48, and then advanced into the channel 42 from the front portion toward the rear portion, with the peripheral side regions of the base 54 being captured by the side flanges 46, 48. The base 54 continues to be advanced into the channel 42 until a peripheral portion of the base 54 is captured by the rear flange 50. When the base 54 is captured by the rear flange, a front peripheral edge of the base 54 may be aligned with (e.g., coplanar with) a front peripheral edge of the main surface 44 such that the base 54 does not protrude beyond the upper body 12.

It is contemplated that the base 54 may include an internal, core layer, such as a plastic or fiberglass mesh, which is covered by a softer, external layer, such as silicone or the like. The internal core layer may help to prevent the base 54 from curving due to the weight of the compression fingers 18. In addition, or as an alternative, the compression element 16 may further include one or more stiffeners 56 (see FIGS. 9 and 10) coupled to the base 54 to resist bending of the base 54. The stiffener 56 may be formed of a material more resistant to bending than the base 54. For instance, the stiffeners 56 may be formed from metal, while the base 54 may be formed from silicone. In one embodiment, the stiffeners 56 are internal to the base 54 or external to the base 54. The stiffeners 56 may be positioned adjacent the peripheral edges of the base 54 and extend generally parallel to the edges of the base 54. Peripherally located stiffeners 56 may also function as a slide-rail to facilitate insertion and removal of the compression element into, and out of, the upper body 12. It is also contemplated that the stiffeners 56 may extend within the interior area of the base 54 (e.g., spaced from the periphery), and may be positioned in a variety of arrangements, such as several parallel stiffeners 56 or stiffeners 56 in an X configuration.

When a bun 20 is inserted into the toaster 10, the flat surface of the bun 20 may be placed against the toasting surface 22. The upper body 12 may be moved from the raised, open position toward the lowered, closed position to bring a plurality of compression fingers 18 into engagement with the bun 20. As each compression finger 18 engages with the bun 20, the compression finger 18 will become compressed to accommodate the thickness of the bun 20. The degree to which each compression finger 18 is compressed will depend on the thickness of the bun 20. In greater detail, a thicker bun 20 will cause a greater degree of compression of the compression finger 18 than a thinner bun 20. The compression of the compression fingers 18 imparts a pressure on the bun 20 against the toasting surface 22. The portion of the bun 20 in direct contact with the toasting surface 22 becomes toasted.

The toaster 10 described herein may be specifically configured and adapted for use within a highly constrained restaurant environment. In this regard, the toaster 10 may be durable and have minimal small parts that could fall into a customer's food. Furthermore, all materials used that could contact the food may be listed as food safe by the United States Food and Drug Administration (FDA), the National Sanitation Foundation (NSF) and the Underwriters' Laboratories (UL). The materials may be able to tolerate high ambient temperatures associated with the toasting process.

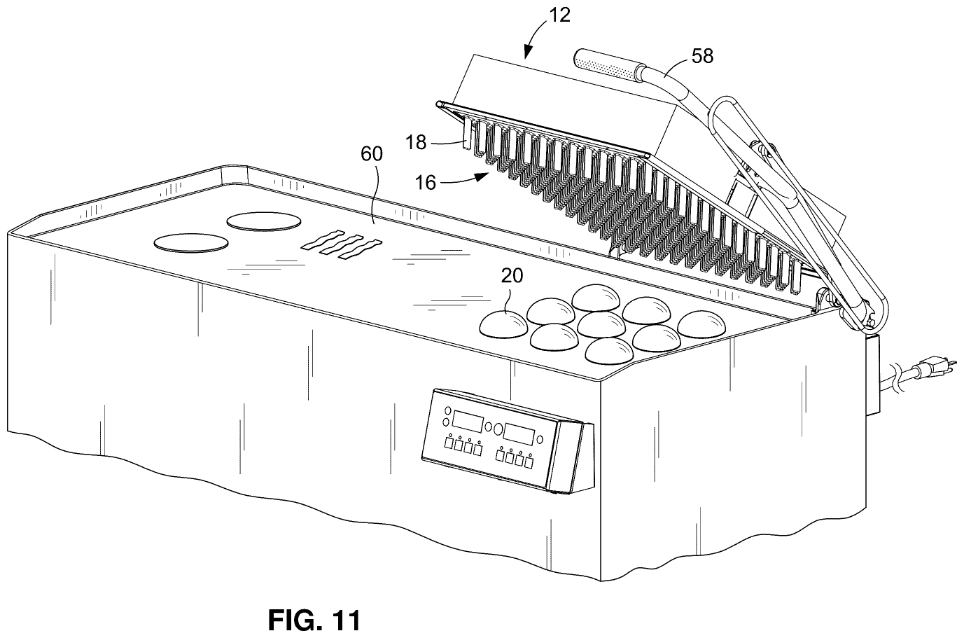

While the toaster 10 described above includes an all-in-one unit including the upper body and lower body 14, referring now to FIG. 11, it is contemplated that the upper body may be an after-market component that is adapted for use with an existing griddle 60. In this regard, the upper body may be mounted directly to the griddle 60 or to the wall (e.g., backsplash or sidesplash) behind the griddle. In either case, the upper body may pivot and translate relative to the griddle between the raised, open position and lowered, closed position, to compress buns 20 against the griddle 60 in a similar manner to that described above.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A clamshell toaster comprising:
a toasting platen having a planar toasting surface configured for toasting a plurality of buns;
an upper body moveable relative to the planar toasting surface between a raised position and a lowered position, the upper body moving toward the planar toasting surface as the upper body transitions from the raised position towards the lowered position; and
a resilient compression element comprising a base and a plurality of compression fingers extending from the base, the base being configured to be slidably engageable with the upper body, the plurality of compression fingers extending from the base at a non-perpendicular angle.

2. The clamshell toaster recited in claim 1, wherein the upper body includes a first end portion, a second end portion opposite the first end portion, and a channel extending between the first and second end portions, the base of the resilient compression element being slidable within the channel.

3. The clamshell toaster recited in claim 2, wherein the upper body includes a main surface and a pair of side flanges each being spaced from the main surface and positioned at respective ones of the first and second end portions, the main surface and the pair of side flanges defining at least a portion of the channel.

4. The clamshell toaster recited in claim 3, wherein the upper body additionally includes a rear flange spaced from the main surface and the pair of side flanges, the rear flange defining at least a portion of the channel.

5. The clamshell toaster recited in claim 4, wherein the pair of side flanges each extend longitudinally in a first direction and the rear flange extends longitudinally in a second direction perpendicular to the first direction.

6. The clamshell toaster recited in claim 1, wherein the plurality of compression fingers are each independently compressible relative to the other ones of the plurality of compression fingers.

7. The clamshell toaster recited in claim 1, wherein the plurality of compression fingers are integrally formed with the base.

8. The clamshell toaster recited in claim 1, wherein the plurality of compression fingers are arranged in a plurality of arrays.

9. The clamshell toaster recited in claim 8, wherein the compression fingers within a given array are offset from the compression fingers in an adjacent array.

10. The clamshell toaster recited in claim 1, wherein each compressible finger includes a rounded tip.

11. The clamshell toaster recited in claim 1, wherein the upper body is pivotable relative to the planar toasting surface between the raised position and the lowered position.

12. The clamshell toaster recited in claim 1, wherein the upper body is pivotable and translatable relative to the planar toasting surface between the raised position and the lowered position.

13. The clamshell toaster recited in claim 1, further comprising a stiffener coupled to the base.

14. A device for compressing a plurality of buns against a planar toasting surface of a toasting platen, the device comprising:
an upper body configured to be moveable relative to the planar toasting surface between a raised position and a lowered position, the upper body moving toward the planar toasting surface as the upper body transitions from the raised position towards the lowered position; and
a resilient compression element comprising a base and a plurality of compression fingers extending from the base, the base being configured to be slidably engageable with the upper body, the plurality of compression fingers extending from the base at a non-perpendicular angle.

15. The clamshell toaster recited in claim 14, wherein the upper body includes a first end portion, a second end portion opposite the first end portion, and a channel extending between the first and second end portions, the base of the resilient compression element being slidable within the channel.

16. The clamshell toaster recited in claim 15, wherein the upper body includes a main surface and a pair of side flanges each being spaced from the main surface and positioned at respective ones of the first and second end portions, the main surface and the pair of side flanges defining at least a portion of the channel.

17. The clamshell toaster recited in claim 16, wherein the upper body additionally includes a rear flange spaced from the main surface and the pair of side flanges, the rear flange defining at least a portion of the channel.

18. The clamshell toaster recited in claim 17, wherein the pair of side flanges each extend longitudinally in a first direction and the rear flange extends longitudinally in a second direction perpendicular to the first direction.

19. The clamshell toaster recited in claim 14, wherein the plurality of compression fingers are each independently compressible relative to the other ones of the plurality of compression fingers.

20. A clamshell toaster comprising:
a toasting platen having a toasting surface configured for toasting a plurality of food items;
an upper body moveable relative to the toasting surface between a raised position and a lowered position, the upper body moving toward the toasting surface as the upper body transitions from the raised position towards the lowered position; and
a compression element comprising a base and a plurality of compression fingers extending from the base, the plurality of compression fingers extending from the base at a non-perpendicular angle.
